(19) United States
(12) Patent Application Publication
(10) Pub. No.: US 2004/0061059 A1
(43) Pub. Date: Apr. 1, 2004

(54) Medical probe for measuring radioactive radiation

(76) Inventors: Thomas Gobel, Berlin (DE); Olaf Hug, Berlin (DE)

Correspondence Address: Jacqueline E Hartt, Allen Dyer Doppelt Milbrath & Gilchrist, 255 South Orange Avenue Suite 1401, PO Box 3791, Orlando, FL, 32802-3791, US

(21) Appl. No.: 10/432,996

(22) PCT Filed: Dec. 3, 2001
(86) PCT No.: PCT/DE01/04594

(30) Foreign Application Priority Data
Dec. 1, 2000 (DE) 10061262.8

(51) Int. Cl. G01T 1/24

(52) U.S. Cl. 250/370.01

(57) ABSTRACT

The invention relates to a medical probe for measuring radioactive radiation, comprising a housing that can be held single-handedly. A detector device (2) comprising a semiconductor diode is disposed in the housing and produces signals that interact with at least one of the following radioactive radiations: αβ⁺, β⁻and γ radiation. A signal processing device (3) processes the signals produced by the detector device (2). A power supply device (4) provides the detector device (2) and the signal processing device (3) with power. The inventive probe is especially characterized in that a reproduction device (5) for reproducing the signals processed by means of the signal processing device (3) is mounted in the housing (1). The inventive device provides a compact measuring system that facilitates an (especially wireless) flexible intraoperative and extraoperative, local measurement of radioactively labeled tissue without requiring additional appliances.

The present invention relates to a medical probe for measuring radioactive radiation according to the preamble of claim 1.

Such a medical probe for measuring radioactive radiation and having a housing that can be held in one hand comprises in this housing a detector device with a semiconductor diode for generating signals interacting with one of the following radioactive radiations: α-, β⁺-, β⁻- and γ-radiation, a signal processing device for further processing the signals generated by the detector device, and a power supply device for the detector device and the signal processing device.

WO 97/42542 discloses such a medical handheld probe. After a radioactive drug has been administered to a patient, the probe enables, for example, a surgeon to distinguish during an operation between tissue not marked radioactively or marked only weakly radioactively and tissue marked radioactively.

However, it is a disadvantage of the handheld probe described in WO 97/42542 that an electronic or electro-optic transceiver is provided in order to transmit the signals generated by means of the detector device of the probe to an external device that determines and displays a counting rate from these signals.

It is therefore the object of the present invention to provide a medical handheld probe for measuring radioactive radiation that, as an autonomous measuring instrument, permits radioactively marked tissue to be measured.

This object is achieved by means of a medical probe having the features of claim 1.

It is provided according to the invention that a reproduction device is arranged in the housing for reproducing the signals processed by means of the signal processing device.

Owing to the combination of detector device, signal processing device, reproduction device and the associated power supply, the medical handheld probe according to the invention constitutes a compact, complete measurement system without cables that enables the flexible intraoperative and extraoperative, local measurement of radioactively marked tissue without additional units.

The reproduction device preferably has means for the acoustic and/or optical reproduction of the processed signals and measured values. A user can thereby track the measurement precisely in a simple way during operation.

In a preferred embodiment, the entire signal processing device can be switched off into a power saving mode, and the power supply device has a control means that supplies the detector device with the stable bias required for detecting the radioactive radiation, the supply being permanently ensured with the aid of this bias independently of the operating state of the signal processing device.

It is expedient for this purpose in a first embodiment that the power supply device comprises a voltage source, and that with the aid of a voltage transformer device the control means keeps ready [sic] the required bias of the detector device from the voltage of the voltage source.

In a second exemplary embodiment, the control means of the power supply device has a voltage source for the bias of the detector device, and the power supply device has a voltage transformer device coupled to the voltage source, the voltage transformer device providing the voltage required for the signal processing device from the voltage of the voltage source.

In a third, preferred exemplary embodiment, the power supply device has a first voltage source for supplying the signal processing device, and the control means of the power supply device provide the bias required for the detector device by means of a second, separate voltage source. Such a second voltage source assigned to the detector device can be constructed with particular ease as a compact series circuit of a plurality of battery elements.

For all the embodiments, the detector device preferably has a scintillator crystal that is optically coupled to the semiconductor diode in a known way.

It is expedient to provide an Si diode, an AIIIBV semiconductor diode or an AIIBVI semiconductor diode as semiconductor diode.

The signal processing device preferably has an electronic discriminator device for selectively suppressing defined signals of the detector device. For this purpose, it is possible to adjust a discriminator threshold such that only signals with levels above the detection threshold trigger the generation of a desired measured value. It is expedient, furthermore, when the discriminator device has an adjustable hysteresis. That is to say, the discriminator threshold that terminates the generation of the desired measured value can be adjusted at a lower level than the triggering discriminator threshold.

The signal processing device preferably has a counting device in order to generate the parameter, widely distributed in dosimetry, of a counting rate. For this purpose, the counting device determines a counting rate from the detector signals filtered by the discriminator device. It is likewise possible to use the detector signals to form a counting rate without filtering them by means of a discriminator circuit.

In order to process further and store externally measured data that the signal processing device has generated, it is expedient when the medical probe additionally has a transmission device for the wireless transmission of the measured data from the probe to an external receiving unit.

It is advantageous, furthermore, that the signal processing device establishes and monitors the energy store of the power supply device. This monitoring, which is designed such that it can be activated automatically and/or manually, informs a user of the handheld probe, for example automatically, of an exchange of batteries soon to be required, or switches the handheld probe off automatically and irreversibly into a safety mode given a low energy store, in order to prevent a surprising failure of the measurement function.

The housing of the handheld probe preferably has an entry opening or an entry region for the radioactive radiation to be measured, the semiconductor detector being arranged on the inside of the housing next to the entry opening or to the entry region.

It is expedient to surround the entry opening or the entry region in radioactive measurement probes in a known way with the aid of a collimator.

The housing of the handheld probe preferably has a shape free from undercuts, and/or can be sterilized from [sic] with the aid of known medical sterilization methods.

In a way similar to a surgical appliance, the housing of the handheld probe is preferably formed in an elongated fashion in such a way that it is held at least by thumb and index finger of an operator, and can be guided like a pen in a single hand in a fashion lying on the back of the hand in a bearing region.

It is expedient for this purpose when the installed groups, such as detector device, signal processing device, power supply device and reproduction device, are arranged and balanced out in the housing in such a way that the position of the centroid of the handheld probe has the effect that the weight force of the handheld probe acts on the back of the hand of an operator via the bearing region of the housing.

A switching device, coupled to the signal processing device, for adjusting and controlling the handheld probe is arranged on the housing of the handheld probe. The switching device preferably has a membrane switch or membrane momentary-contact pushbutton with a plastic or metal membrane.

It is expedient to arrange at least one membrane switch on the housing in such a way that the index finger and/or thumb of an operator come/comes to lie on this membrane switch as the handheld probe is being guided. As a result, it is possible, in particular, for an operator to determine the associated measured value of the radioactive radiation at a site, desired by him, of the tissue to be examined, and to store it by actuating the membrane switch.

It is expedient that the signal processing device for the handheld probe has a microcontroller. This microcontroller controls and monitors the signal processing device, the power supply device and the reproduction device.

The detector device and the associated signal processing device are preferably designed in such a way that radioactive radiation can be optimally detected in an energy spectrum from 5 keV to 511 keV.

Preferred exemplary embodiments of the medical handheld probe are explained with the aid of the following drawings.

In the drawing:

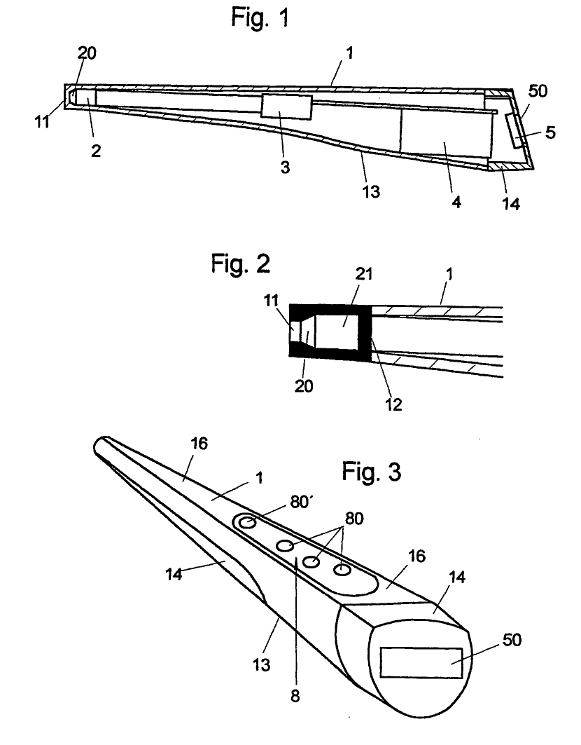

FIG. 1 shows a schematic sectional view along the longitudinal axis of the medical measurement probe;

FIG. 2 shows a perspective external view of the medical probe;

FIG. 3 shows a detailed view of the detector device arranged at the tip of the probe, in longitudinal section;

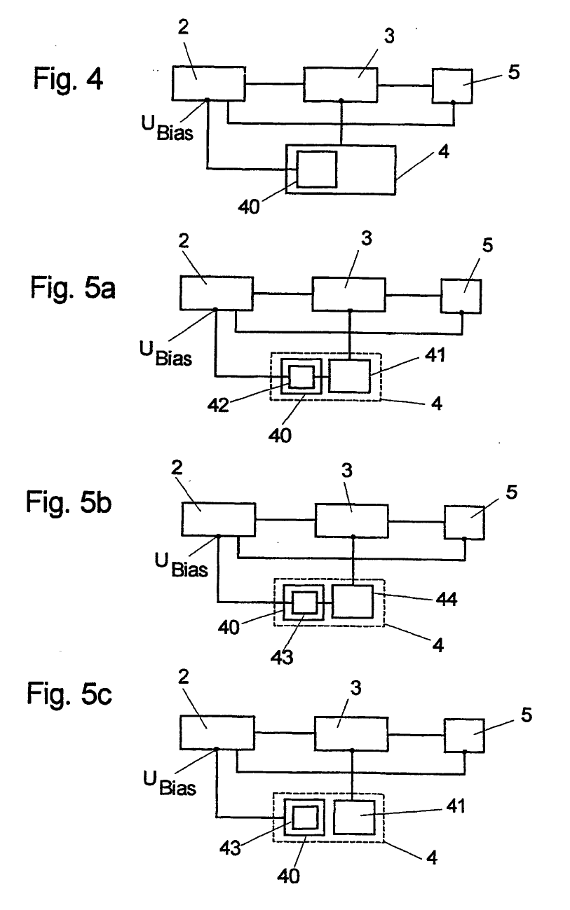

FIG. 4 shows a block diagram of the different modules of the medical probe;

FIG. 5a shows the block diagram of the modules of a first exemplary embodiment of the handheld probe;

FIG. 5b shows the block diagram of the modules of a second exemplary embodiment of the handheld probe;

FIG. 5c shows the block diagram of the modules of a third exemplary embodiment of the handheld probe;

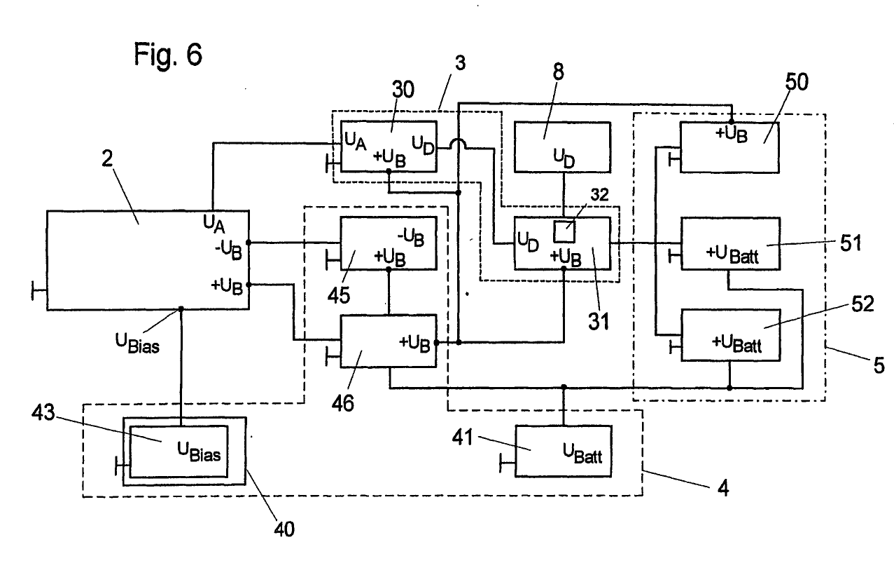

FIG. 6 shows a detailed block diagram of the modules of a handheld probe in accordance with the third exemplary embodiment from FIG. 5c;

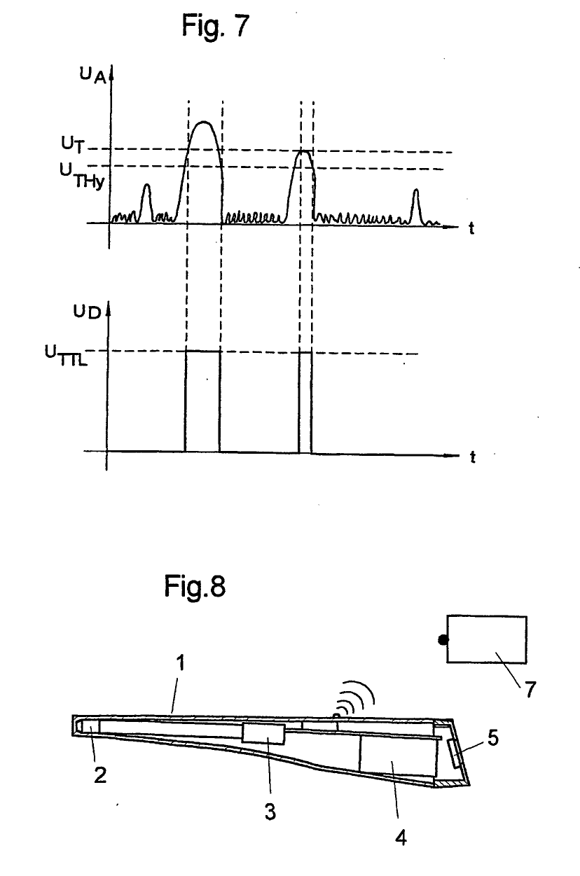

FIG. 7 shows a schematic of the mode of operation of the discriminator device of the handheld probe; and

FIG. 8 shows a further embodiment of the handheld probe, with a wireless transmission device for transmitting measured values to an external receiving device.

The medical handheld probe for radiation measurement is shown in a longitudinal illustration in FIG. 1. Starting from a broader first end region, where it has a cover lid 14, the housing 1 tapers along its longitudinal direction to a narrow second end region. Arranged in the interior of the housing 1 at the tip of the second, narrow end region is a detector device 2 with a semiconductor diode 20. The semiconductor diode 20 is positioned behind an entry region 11, arranged integrally in the narrow tip of the housing 1, for the radioactive radiation to be detected.

Starting from the detector device 2, there are arranged one after another in the direction of the widening second end region of the housing 1 a signal processing device 3, a power supply device 4 and, in the cover lid 14, a reproduction device 5 that has an LCD display 50. The reproduction device furthermore preferably comprises a loudspeaker, arranged in the interior of the housing 1, and, in addition to the LCD display 50, an LED display, in order to reproduce determined measured values optically and acoustically. The measured values are formed from the signals of the detector device 2, these signals being further processed further [sic] by the signal processing device 3.

The cover lid 14 can be taken off from the front housing part so as thereby to permit access to the interior of the housing 1, in particular to the power supply device.

The overall housing 1, that is to say the front, elongated housing part and the cover lid 14, is produced from plastic or metal, the material used permitting a customary medical sterilization of the housing 1. It is particularly significant in the interest of sterilizability and cleaning that the housing 1 has no undercuts of any type, and the joint between the cover lid 14 and the front, tapering housing part is designed to be as narrow as possible. However, it is also conceivable that the handheld probe be used with a sterile coating that, in a suitable form, permits the probe to be operated, in particular renders it possible to read off the display 50.

A compact probe without cables can be created with the aid of a probe such as that illustrated in FIG. 1.

It is to be understood by the term probe without cables that there is no connection in the form of a cable, a line or, for example, a glass fiber between the probe and an assigned external device, particularly for supplying the probe with power or transmitting measured data between the probe and the external device. This property is important, since a cable leading away from the probe would produce undesirable limitations with regard to the radius of movement and the manipulability of the probe. The high user-friendliness required by surgeons, in particular, requires a probe that can be held and guided in one hand and is designed without cables in the sense described above.

FIG. 2 shows an enlarged detailed view of a longitudinal section of the probe tip in which there is positioned the detector device 2 comprising the semiconductor diode 20 and a scintillator crystal 21. The entry region 11 for the radioactive radiation to be detected is constructed in the housing tip. The entry region 11 is appropriately adapted to the type of the radioactive radiation. Detection of α-radiation, in particular, requires the housing 1 to be of as thin a design as possible in the entry region 11 so that the radiation experiences no excessive attenuation. Instead of an integral design of the entry region 11 in the housing 1, it would likewise be conceivable to provide an entry window closed by a thin metal membrane.

The semiconductor diode 20 is arranged on the housing inner side of the entry region 11. Silicon PIN diodes, AIIIBV semiconductor diodes or AIIBVI semiconductor diodes, in particular, are suitable as semiconductor diode 20, depending on the requirements.

In order to increase the sensitivity, in particular for higher-energy radioactive radiation, the semiconductor diode 20 is assigned the scintillator crystal 21. The scintillator 21 must be optically coupled to the semiconductor diode 20 for this purpose. From the point of view of the radioactive radiation falling into the housing 1 through the entry region 11, the scintillator 21 in FIG. 2 is arranged downstream of the semiconductor diode 20. However, the inverse geometric arrangement, or the use of a plurality of scintillators, would also likewise be conceivable. CsJ, NaJ or BGO crystals constitute suitable scintillators depending on the parameters of the radiation to be detected.

It is advantageous to surround the semiconductor diode 20 and scintillator 21 with a collimator 12 so that the semiconductor diode 20 specifically detects the radioactive radiation falling in through the entry region. The collimator 12 produced from a metal with a high absorption coefficient for radioactive radiation (for example tungsten) completely surrounds the semiconductor diode 20 and scintillator 21, and leaves just one opening, which is next to the entry region 11.

FIG. 3 shows a perspective view of the housing 1 of the medical handheld probe. The components identical to FIG. 1 are provided with the same reference numerals. Starting from the first, wider end section of the housing 1, which has the cover lid 14 with the LCD display 50 arranged therein, the housing 1 tapers toward the second, narrow end region of the housing 1.

However, the housing 1 does not taper symmetrically relative to its longitudinal axis. It has a flat surface 16 that is substantially triangular in design owing to the tapering form of the housing. In the first, wide end section, the housing 1 with the cover lid 14 is designed along the first third of the longitudinal axis of the probe substantially in the form of a conical envelope section that connects the two longitudinal edges of the flat surface 16. This conical envelope section merges along the longitudinal axis of the probe up to the probe tip into a continuously tapering organically ergonomic form with finger-grip depressions 14 pointing toward the inside of the housing. The finger-grip depressions 14 extend in pairs symmetrically along the longitudinal axis of the probe on both sides of the probe.

This ergonomic form of the housing 1 permits an operator to guide the medical probe with one hand in a fashion similar to a pen. In this process, the probe rests with a bearing region 13, arranged in front of the finger-grip depressions 14 in the direction of view toward the probe tip, on the back of the hand of the operator, the index finger coming to lie on the flat probe surface 16, the thumb coming to lie in one finger-grip depression 14, and the middle finger coming to lie in the other finger-grip depression 14.

It is particularly user-friendly in this case when the centroid of the medical probe is arranged not far from the bearing region 13 such that the probe also lies balanced out on the back of the hand of an operator even without fixing by his fingers.

In order to operate the medical probe, a switching device 8 with membrane switches 80 is arranged on the flat surface 16. The membrane switches or membrane momentary-contact pushbuttons with a plastic or metal membrane must likewise fulfill the abovedescribed requirements for sterilizability.

At least one membrane switch 80′ is arranged along the longitudinal axis of the probe in such a way that the index finger of the operator, who, as previously described, guides the probe like a pen, comes to lie on this membrane switch 80′. By actuating this membrane switch 80′, the operator can store a measured value that has, for example, been determined during an operation on a defined tissue section in an electronic memory of the signal processing device 3, and “freeze” to the [sic] display. It is likewise conceivable to provide a membrane switch in a finger-grip depression 14 such that it can be actuated by the thumb.

The remaining membrane switches 80 are arranged in the wider end region of the probe such that the operator cannot reach you [sic] with his fingers in the “pen hold” described above. The operator must hold the handheld probe like a baton with the wider end at the top in order to be able to operate these membrane switches. In this case, the operator grasps the bearing region 13 with an inner surface of his hand, and the membrane switches 80 can be actuated by the thumb in a simple way.

The cover lid 14 has a display 50 arranged beveled in relation to the flat surface 16 of the housing 1 in such a way that the display 50 can be read off without a problem by the operator even in the abovedescribed “baton hold” in a top view of the flat surface 16. It is provided that an operator can control and vary the presettings of the handheld probe in the “baton hold” by means of the membrane keys 80.

An operator will normally guide the handheld probe in the “pen hold” for measurement operation. In this case, the side of the display 50 facing the flat surface 16 is the top side for the measured values displayed. In the “baton hold”, precisely the reverse applies, the side of the display 50 facing the flat surface 16 being the underside for the adjustment parameters displayed on the display 50. Consequently, the orientation of the display 50 is rotated by 180° as soon as the operator switches between measurement mode and adjusting mode. This rotation of the display constitutes an additional safeguard for the measurement operation. If the operator who is guiding the probe for a measurement in the “pen hold” accidentally triggers the adjusting mode by actuating the appropriate membrane switches 80, the display is rotated so as to exclude the reading of a supposed measured value erroneously.

An autonomous medical measurement system, without cables, for radioactive radiation is provided by combining the detector device, signal processing device, power supply device and reproduction device in a common housing of a medical handheld probe that permits operation entirely with one hand owing to its previously described design and its geometric shape. This measurement system is suitable without additional units for immediate intraoperative and extraoperative, local measurement of radioactive radiation.

Medical probes for measuring radioactive radiation that are operated with the aid of a battery or a rechargeable battery frequently have the disadvantage that the power supply suffices only for a period of a few dozen working hours. The operation of such probes requires additional management of batteries and rechargeable batteries in the clinics, it never being possible entirely to eliminate the risk of a failure of the unit during the operation.

It is therefore desirable to maximize the number of working hours of a medical probe that are possible per battery of rechargeable battery, without the need to increase the capacity of the electric power supply in the process. It is desirable for the management of batteries or rechargeable batteries in the clinic to be completely eliminated so that the operation of the unit is simplified and the risk of undesired failure of the unit is reduced.

Probes with a semiconductor diode as radiation detector, in particular, have the disadvantage that, with each renewed starting of the measurement function of the handheld probe out of an energy saving mode, 20 to 30 seconds normally elapse until the probe is ready to measure. This is caused by the resulting time constant of the capacitive and ohmic components of the bias voltage supply of the semiconductor diode.

A “startup phase” of 20 to 30 seconds constitutes a burdensome and therefore undesired restriction for the operator of the handheld probe, particularly during a surgical operation.

FIG. 4 shows a block diagram of the different modules of the medical probe. The power supply device 4 supplies the detector device 2, the signal processing device 3 and the reproduction device 5 with electric energy (for example battery, rechargeable battery).

The electronic components of detector device 2, signal processing device 3 and reproduction device 5 have a power consumption that is as low as possible so that the handheld probe can be used for as long as possible without the need to change batteries or rechargeable batteries. Such components are used, for example, in mobile radio engineering and are therefore known in principle.

In order to handle the store of energy in the power supply device 4 as economically as possible, the signal processing device can preferably be switched off into an energy saving mode.

Furthermore, the power supply device 4 has control means 40 that supply the detector device 2 with the bias U_{Bias} required for the semiconductor diode 20, the provision of the bias U_{Bias} being ensured by the control means 40 independently of the operating state of the signal processing device 3.

Owing to the fact that, via its bias U_{Bias}, the semiconductor diode 20 has a power consumption that is negligibly low by comparison with the electronic components of the signal processing device 3, there is no need to switch off the bias U_{Bias} in the energy saving mode of the handheld probe.

This has the advantage that upon activation from the energy saving mode into the measurement mode the handheld probe is ready to measure within a time period of less than one second. If the bias U_{Bias} were likewise first switched on upon this activation, the readiness to measure would not be reached until after a time period of 20 to 30 seconds, because the capacitive and ohmic components of the bias voltage supply demand such a long switch-on time.

The principle described above that the the [sic] control means 40 of the power supply device 4 supply the semiconductor diode 20 with the bias U_{Bias} independently of the operating state of the signal processing device 3 can be realized, in particular, by means of the three exemplary embodiments described below.

FIG. 5a illustrates the block diagram of the modules of a first exemplary embodiment of the handheld probe. In this case, the power supply device 4 has a voltage source 41 that can be designed as a battery or rechargeable battery, and the control means 40 has a voltage transformer device 42 that generates the bias U_{Bias} by means of the voltage of the voltage source 41, and provides the semiconductor diode of the detector device 2 with it.

FIG. 5b shows the block diagram of the modules of a second exemplary embodiment of the handheld probe. In contrast to the exemplary embodiment shown in FIG. 5a, the control means 40 of the power supply device 4 have a voltage source 43 for providing the bias U_{Bias}. The voltage U_{Bias} is therefore not transformed from a battery voltage, for example, rather the voltage source 43 provides U_{Bias} without the interposition of a voltage transformer.

The power supply device 4 further comprises a voltage transformer device 44 that provides the electric energy required for the measurement operation of the detector device 2, the signal processing device 3 and the reproduction device 5 from the voltage source 43 of the control means 40.

FIG. 5c shows the block diagram of the modules of a third exemplary embodiment of the handheld probe. Here, the power supply device 4 has a first voltage source 41 for supplying energy during measurement operation of the detector device 2, the signal processing device 3 and the reproduction device 5, and the control means 40 of the power supply device 4 comprises a second voltage source 43 for supplying the detector device 2 with the bias U_{Bias}. In contrast to the exemplary embodiments shown in FIGS. 5a and 5b, the power supply device 4 has two decoupled, separate voltage sources 41 and 43. This exemplary embodiment has the advantage that the necessary electronics of an additional voltage transformer device are eliminated. Because of the low power consumption of the semiconductor diode 20 via the applied bias U_{Bias}, the voltage source 43 designed as a battery or rechargeable battery has service lives of several years. Moreover, it can, for example, be designed as a series circuit of individual battery elements in a way that saves space and weight.

FIG. 6 shows a detailed block diagram of the modules of a handheld probe in accordance with the third exemplary embodiment from FIG. 5c.

The power supply device 4, which has the components bordered by dashes, comprises a first voltage source 41 with two assigned voltage transformers 45 and 46 for supplying the detector device 2, the signal processing device 3 with the discriminator device 30, the counting device 31 with microcontroller 32 and the components 50, 51, 52 of the reproduction device 5, and the control means 40 with a second voltage source 43 for supplying the detector device 2 with the bias U_{Bias}. The voltage transformers 45 and 46 are required for the purpose of providing, in addition to the voltage U_{Batt} provided by the second voltage source 41, two further potentials +U_{B} and −U_{B} for the electronic components.

Both potentials −U_{B} and +U_{B} are connected to the detector device 2, and the analog voltage signals U_{A} generated in the semiconductor diode of the detector device upon the detection of the radioactive radiation are fed to the signal processing device 3. The signal processing device 3 has, bordered by dots and dashes [sic], a discriminator device 30 and a counting device 31 with a microcontroller 32. An additional preamplification of the analog voltage pulses U_{A} can be provided upstream of the discriminator device 30 in a known way.

As set forth in the following description of FIG. 7, digital output pulses U_{D}, for example TTL pulses, are generated by the discriminator device 30 from analog incoming voltage pulses that exceed an adjustable discriminator threshold.

The generated digital output signals U_{D} are fed to the microcontroller 32, which generates therefrom with the aid of the counting device 31 a counting rate that can be reproduced optically and/or acoustically as measured value by means of the reproduction device 5. The microcontroller 32 is designed as a part of the counting device 31 in the embodiment illustrated.

The reproduction device 5 comprises the components, bordered by dots and dashes, of an LCD display 50, a loudspeaker 51 and an LED display 52. It is provided that the measurement operation carried out by means of the detector device 2 and the signal processing device 3 can be executed as a relative measurement of the dose via the loudspeaker 51 (sound volume and/or frequency of the sound) and the LED display 52 (deflection of an LED display column) and/or as a relative measurement of the dose rate [lacuna] the counting rate determined in the form of the numerical value on the display 50.

A keyboard device 8 coupled to the microcontroller 32 is provided and permits the operator to change the presettings such as type of measurement, type of reproduction of the measurement result, adjustment of the discriminator threshold etc.

The microcontroller 32 is designed as an electronic low power component that shifts the components of the measuring and control electronics (signal processing device 3 and, via the power supply device 4, the detector device 2) into a power saving mode (sleep mode) after a prescribed period of inactivity. The microcontroller 32 also takes over the monitoring of the charging state of the voltage sources 41 and 43, and signals the need to change the respective batteries or rechargeable batteries. Furthermore, the microcontroller 32 switches off the unit even before failure of the voltage sources 41 and 43, and prevents resumption of operation with a battery or rechargeable battery that is almost empty.

Alternatively, the circuit illustrated in FIG. 6 can also be used with the power supply devices 4 in accordance with the first or second exemplary embodiment (FIGS. 5a and 5b).

A schematic illustration of the mode of operation of the discriminator device 30 of the handheld probe is illustrated in FIG. 7.

Only the analog input signal pulses U_{A} that just reach or exceed the adjustable discriminator threshold U_{T} generate the rising edge of a digital output pulse U_{D}. The falling edge of the digital output pulse U_{D} is generated when the falling edge of the recorded analog signal pulse drops below the adjustable threshold U_{THY}. Because the level threshold U_{THY} for the falling edge of the generated digital output pulse U_{D} can be adjusted to below the discriminator threshold U_{T}, the discriminator device 30 has an adjustable hysteresis.

The discriminator device 30 ensures together with the use of a collimator 12 illustrated in FIG. 2 a suppression of the noise occurring and of the scattered radiation.

It is expedient to optimize the detector device 2 and signal processing device 3 to the energy spectrum of the radiation to be detected. This is basically in the range from 5 keV to 511 keV. The handheld probe can be designed, in particular, for the application of radioactive drugs in the range from ^{99m}Tc (140 keV) to ¹³¹I (364 keV).

It is illustrated [lacuna] FIG. 8 that each of the abovedescribed handheld probes can additionally be designed with a wireless transmission device 6 for transmitting measured values to an external receiving device 7. Suitable for this purpose are transmission devices known from the prior art that transmit the digital measurement signals in the form, for example, of infrared optical pulses or electromagnetic radiation to an external receiving device.

1. A medical probe for measuring radioactive radiation, having a housing (1) that can be held in one hand and in which there are arranged:
at least one detector device (2), comprising a semiconductor diode (20), for generating signals interacting with at least one of the following radioactive radiations: α-, β⁺-, β⁻- and γ-radiation,
a signal processing device (3) for further processing the signals generated by the detector device (2), and
of a [sic] power supply device (4) for the detector device (2) and the signal processing device (3),
characterized
in that a reproduction device (5) is arranged in the housing (1) for reproducing the signals processed by means of the signal processing device (3).

2. The medical probe as claimed in claim 1, characterized by a reproduction device (5) for the optical and/or acoustic reproduction of the processed signals and/or measured values derived therefrom.

3. The medical probe as claimed in claim 1 or 2, characterized in that the signal processing device (3) has a power saving mode, and the power supply device (4) has a control means (40) for providing a stable bias (U_{Bias}), required for detecting the radioactive radiation, of the detector device (2) with the semiconductor diode (20), the provision of the bias (U_{Bias}) being independent of the operating state of the signal processing device (3).

4. The medical probe as claimed in claim 3, characterized in that the power supply device (4) has a voltage source (41), [lacuna] the control means (40) has a voltage transformer device (42) that provides the required bias of the detector device (2) by means of the voltage source (41).

5. The medical probe as claimed in claim 3, characterized in that the control means (40) from the power supply device (4) has a voltage source (40), and the power supply device (4) has a voltage transformer device (44), coupled to the voltage source (43), for providing the voltage required for the signal processing device (3).

6. The medical probe as claimed in claim 3, characterized in that the power supply device (4) has a first voltage source (41) for the signal processing device (3), the reproduction device (5) and the detector device (2), and the control means (40) of the power supply device (4) have a second voltage source (43) for providing the bias for the detector device (2).

7. The medical probe as claimed in claim 6, characterized in that the second voltage source (43) assigned to the detector device (2) has a series circuit of individual battery elements.

8. The medical probe as claimed in one of the preceding claims, characterized in that the detector device (2) comprises a scintillator crystal (21) that is optically coupled to the semiconductor diode (20).

9. The medical probe as claimed in one of the preceding claims, characterized in that the semiconductor diode (20) is designed as an Si diode, as an AIIIBV semiconductor diode, or as an AIIBVI semiconductor diode.

10. The medical probe as claimed in one of the preceding claims, characterized in that the signal processing device (3) comprises an electronic discriminator device (30) for the signals of the detector device (2).

11. The medical probe as claimed in claim 10, characterized in that the level of the discriminator threshold (UT) of the electronic discriminator device (30) is adjustable.

12. The medical probe as claimed in claim 11, characterized in that the discriminator threshold (UT) has an adjustable hysteresis (UTHy).

13. The medical probe as claimed in one of the preceding claims, characterized in that the signal processing device (3) has a counting device (31) for the signals of the detector device (2) for the purpose of generating a counting rate.

14. The medical probe as claimed in one of claims 10 to 12, characterized in that the signal processing device (3) has a counting device (31) that forms a counting rate from the signals of the detector device (2) that are not suppressed by the electronic discriminator device (30).

15. The medical probe as claimed in one of the preceding claims, characterized in that the signal processing device (3) generates measured data from the signals of the detector device (2), and the medical probe has a transmission device (6) for the wireless transmission of the measured data from the medical probe to an external receiving device (7).

16. The medical probe as claimed in one of the preceding claims, characterized in that the energy store of the power supply device (4) can be determined automatically and/or manually and controlled by means of the signal processing device (3).

17. The medical probe as claimed in one of the preceding claims, characterized in that the housing (1) has an entry opening or an entry region (11) for the radioactive radiation, the semiconductor diode (20) of the detector device (2) being arranged at the entry opening or at the entry region (11).

18. The medical probe as claimed in claim 17, characterized in that the medical probe has a collimator (12) surrounding the entry opening or the entry region (11).

19. The medical probe as claimed in one of the preceding claims, characterized in that the housing (1) has a geometry free from undercuts.

20. The medical probe as claimed in one of the preceding claims, characterized in that the surface of the housing (1) can be sterilized with the aid of conventional medical sterilization methods.

21. The medical probe as claimed in one of the preceding claims, characterized in that the housing (1) is designed in an elongated form in such a way that during use of the medical probe the housing (1) can be held like a pen in the hand of an operator in a fashion supported by the back of the hand in a bearing region (13) located on the housing, and supported by at least thumb and index finger.

22. The medical probe as claimed in claim 21, characterized in that the centroid of the medical probe is arranged along its longitudinal axis at the level of the bearing region (13) of the housing (1).

23. The medical probe as claimed in one of the preceding claims, characterized in that the housing (1) has a switching device (8), coupled to the signal processing device [lacuna] 3 [lacuna], for controlling the medical probe.

24. The medical probe as claimed in claim 23, characterized in that the switching device (8) have [sic] membrane switches (80) with a plastic or metal membrane.

25. The medical probe as claimed in claim 24, characterized in that at least one membrane switch (80) is arranged in such a way that the latter can be actuated with the index finger and/or the thumb of the operator, in particular in order to store a determined measured value by means of a hold function.

26. The medical probe as claimed in one of the preceding claims, characterized in that the signal processing device (3) comprises a microcontroller (32) for controlling the signal processing device (3), for controlling and monitoring the power supply device (4), and for controlling the reproduction device (5).

27. The medical probe as claimed in one of the preceding claims, characterized in that the detector device (2) and the signal processing device (3) are optimized for detecting radioactive radiation in the range from 5 keV to 511 keV.
